(19) United States
(12) Patent Application Publication
(10) Pub. No.: US 2015/0104605 A1
(43) Pub. Date: Apr. 16, 2015

(54) HONEYCOMB CORE STRUCTURE

(71) Applicant: E I DU PONT DE NEMOURS AND COMPANY, Wilmington, DE (US)

(72) Inventor: Jill A. Conley, Midlothian, VA (US)

(21) Appl. No.: 14/401,649

(22) PCT Filed: May 17, 2013
(86) PCT No.: PCT/US13/41493

§ 371 Date: Nov. 17, 2014

Related U.S. Application Data
(60) Provisional application No. 61/653,526, filed on May 31, 2012.

(51) Int. Cl. B32B 3/12; B32B 15/088; B32B 27/34

(52) U.S. Cl. CPC B32B 3/12; B32B 27/34; B32B 15/088; B32B 2255/02; B32B 2305/024; B32B 2305/07; B32B 2305/22
USPC 428/116

(57) ABSTRACT

A thermoplastic honeycomb core structure comprises from 40 to 90 weight percent of an aliphatic polyamide polymer and from 10 to 60 weight percent of discontinuous fibers distributed evenly throughout the polymer wherein (i) the honeycomb is free of fused cell walls, (ii) the fibers are carbon, glass, para-aramid or a combination thereof, and (iii) the fibers have a length of from 0.5 to 10 mm.

### BACKGROUND

1. Field of the Invention

This invention pertains to a fiber-reinforced thermoplastic honeycomb and articles made from the honeycomb.

2. Description of Related Art

U.S. Pat. No. 5,217,556 to Fell describes a thermoplastic honeycomb prepared by a continuous or semi-continuous process. In the process, a pre-corrugated or non-corrugated web of fiber-reinforced or non-reinforced thermoplastic is laid up and consolidated into a honeycomb layer by layer, each layer representing a half cell height of the finished honeycomb.

U.S. Pat. No. 5,421,935 to Dixon and Turner describes a method and apparatus for forming a honeycomb structure in which a plurality of thermoplastic layers are fused together at selected locations. The thermoplastic layers at each of the selected locations are melted together to form a welded portion which includes first and second exterior surfaces. The welding of the thermoplastic layers is controlled so that no more than one of the exterior surfaces is melted. This partial melting of one layer prevents undesirable welding to adjacent layers.

U.S. Pat. No. 5,421,935 to Landi and Wilson describes a resilient panel having anisotropic flexing characteristics in which thermal compression bonding techniques have been used to laminate a plurality of sheets of thermoplastic polyurethane material together with bonds that are in strip form, spaced at regular intervals, and staggered between alternate sheets of material. The laminated stack was then cut into slices of appropriate thickness, and the slices were expanded to form a honeycombed core which, while held in spread apart disposition, was thermally pre-formed and made ready to receive facing materials.

The above three patents all involve at least a two step process. The first step is the making of a thermoplastic web and the second step involves conversion of the web into a honeycomb. There is an ongoing need to provide a single step process and a product having improved mechanical properties.

### SUMMARY OF THE INVENTION

This invention pertains to a thermoplastic honeycomb core comprising from 40 to 90 weight percent of an aliphatic polyamide polymer and from 10 to 60 weight percent of discontinuous fibers distributed evenly throughout the polymer wherein

(i) the honeycomb is free of fused cell walls,

(ii) the fibers are carbon, glass, para-aramid or a combination thereof, and

(iii) the fibers have a length of from 0.5 to 10 mm.

### BRIEF DESCRIPTION OF THE DRAWINGS

FIG. 1A is a partial planar view of a prior art thermoplastic honeycomb.

FIG. 1B is a detailed view of a portion of honeycomb shown in FIG. 1A.

FIG. 2A is a partial planar view of a thermoplastic honeycomb of this invention.

FIG. 2B is a detailed view of a portion of honeycomb shown in FIG. 2A.

FIG. 3 is an elevation view of a honeycomb core.

FIG. 4 is a representation of another view of a hexagonal cell shaped honeycomb.

FIG. 5 is an illustration of honeycomb provided with facesheet(s).

### DETAILED DESCRIPTION

This invention pertains to a fiber-reinforced thermoplastic honeycomb core comprising from 40 to 90 weight percent of an aliphatic polyamide polymer and from 10 to 60 weight percent of discontinuous fibers distributed evenly throughout the polymer. The weight percent is based on the total weight of fiber plus polymer. The honeycomb is free of fused cell walls.

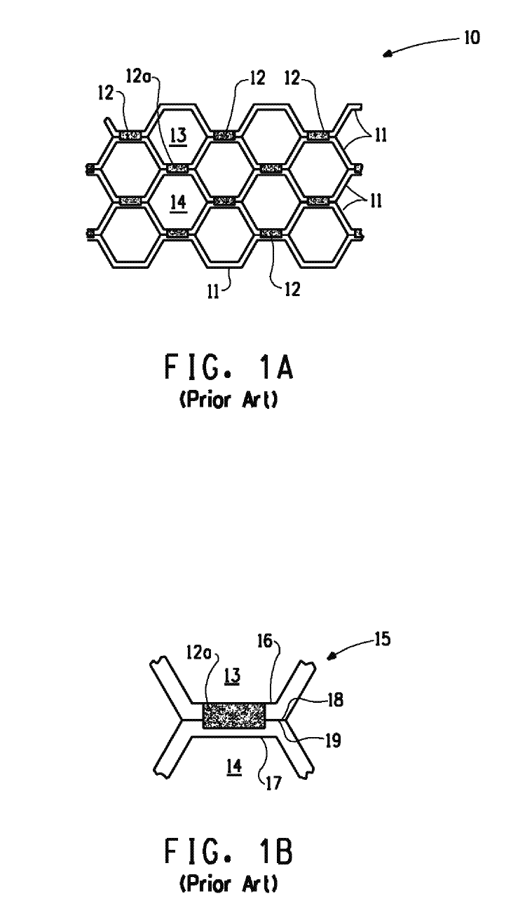

FIG. 1A shows generally at 10 a partial planar view of a prior art thermoplastic honeycomb. The honeycomb is made from a plurality of thermoplastic webs 11 that have been expanded into a honeycomb structure. The individual webs are fused or bonded together in regions as shown at 12. This fused region forms the fused cell walls of adjacent cells. An example of fused cell walls are shown at 12a between cells 13 and 14. FIG. 1B is a more detailed view 15 of a portion of honeycomb in the region of the fused cell walls of cells 13 and 14 as shown in FIG. 1A. The inner cell walls of cells 13 and 14 are shown at 16 and 17 respectively. The outer cell walls of cells 13 and 14 are shown at 18 and 19 respectively. The fused cell walls are shown at 12a. This technology is further detailed in U.S. Pat. No. 5,421,935.

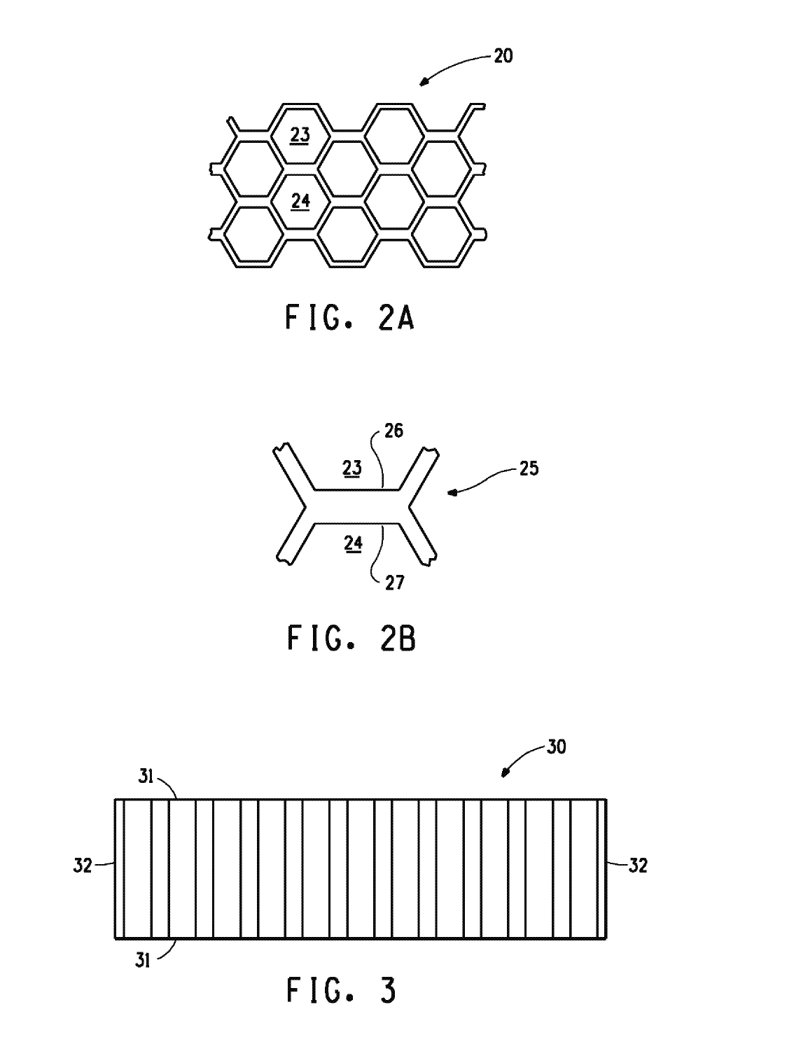

FIG. 2A shows generally at 20 a partial planar view of a thermoplastic honeycomb of this invention. Representative cells 23 and 24 are shown. FIG. 2B is a more detailed view 25 of a portion of honeycomb in the region of the cell 23 and 24 as shown in FIG. 2A. Unlike cells 13 and 14 in FIG. 1B there are no outer cell wall equivalents to 18 and 19. The honeycomb of this invention has only inner cell walls 26 and 27. That is to say that the honeycomb is free of fused cell walls like 12 and 12a.

In some embodiments, the fibers of this invention have a length of from 0.5 to 10 mm. In some embodiments, the fibers have a length of from 2 to 7 mm or even from 3 to 5 mm. The fibers comprise from 5 to 60 weight percent of the weight of polymer plus fiber. In some embodiments, the fibers comprise from 15 to 50 weight percent and in other embodiments from 20 to 40 weight percent. The fibers are distributed evenly throughout the polymer. In one embodiment, the fibers are randomly oriented within the polymer. In another embodiment, at least 20 percent of the fibers are oriented in a particular direction. Fiber orientation may be achieved through specific die configurations when extruding the fiber-polymer blend.

The fibers are of carbon, glass, para-aramid or a combination thereof.

Suitable glass fibers include E-glass and S-glass fiber. E-Glass is a commercially available low alkali glass. One typical composition consists of 54 weight % SiO₂, 14 weight % Al₂O₃, 22 weight % CaO/MgO, 10 weight % B₂O₃ and less then 2 weight % Na₂O/K₂O. Some other materials may also be present at impurity levels. S-Glass is a commercially available magnesia-alumina-silicate glass. This composition is stiffer, stronger, more expensive than E-glass and is commonly used in polymer matrix composites.

Para-aramid is a polyamide wherein at least 85% of the amide (—CONH—) linkages are attached directly to two aromatic rings. Suitable aramid fibers are described in Man-Made Fibres—Science and Technology, Volume 2, Section titled Fibre-Forming Aromatic Polyamides, page 297, W. Black et al., Interscience Publishers, 1968.

A preferred para-aramid is poly(p-phenylene terephthalamide) which is called PPD-T. By PPD-T is meant a homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Another suitable fiber is one based on aromatic copolyamide prepared by reaction of terephthaloyl chloride (TPA) with a 50/50 mole ratio of p-phenylene diamine (PPD) and 3,4′-diaminodiphenyl ether (DPE). Yet another suitable fiber is that formed by polycondensation reaction of two diamines, p-phenylene diamine and 5-amino-2-(p-aminophenyl) benzimidazole with terephthalic acid or anhydrides or acid chloride derivatives of these monomers.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

Para-aramid fibers are available commercially as Kevlar® fibers, which are available from E. I. du Pont de Nemours & Co. , Wilmington, Del. (“herein DuPont”) and Twaron® fibers, which are available from Teijin Aramid B V, Arnhem, Netherlands.

Carbon fiber used in this invention may be in the form of short cut or chopped fiber, also known as floc. Floc is made by cutting continuous filament fibers into short lengths without significant fibrillation. An example of a suitable length range is from 1.5 mm to 20 mm. Carbon fibers suitable for use in this invention can be made from either polyacrylonitrilie (PAN) or pitch precursor using known technological methods, for example as described in: J. B. Donnet and R. C. Bansal. Carbon Fibers, Marcel Dekker, 1984. Suppliers of chopped carbon fibers include Hexcel Corporation, Cytec Engineered Materials and Toray Industries.

In other embodiments of the invention, the fibers may be carbon nanotubes (CNT's) or other nanofibers either used alone or in combination with other fibers that have a length of at least 1 micrometer.

The polymer is an aliphatic polyamide. Suitable polyamides include nylon 6, nylon 66 or polyphthalamide. The polymer comprises from 40 to 90 weight percent of the weight of polymer plus fiber. In some embodiments, the polymer comprises from 50 to 85 weight percent and in other embodiments from 60 to 80 weight percent. Such materials are available under the tradename ZYTEL® from DuPont.

The honeycomb of this invention is made by an extrusion process. Pellets or flake comprising a blend of fibres evenly distributed in a polymer are fed via an extruder through a die. The die has the desired shape of the honeycomb core. Hexagonal, square, over-expanded and flex-core cells are among the most common cell shapes. Such cell types are well known in the art and reference can be made to Honeycomb Technology pages 14 to 20 by T. Bitter (Chapman & Hall, publishers, 1997) for additional information on possible geometric cell types.

The thermoplastic honeycomb described above may be incorporated into a composite article such as a composite sandwich panel. FIG. 3 is an elevation view 30 of the honeycomb shown in FIG. 2A and shows the two exterior surfaces, or faces 31 formed at both ends of the cells. The core also has edges 32. FIG. 4 is a three-dimensional view of the thermoplastic honeycomb, The “T” dimension or the thickness of the honeycomb is shown at 40 in FIG. 4.

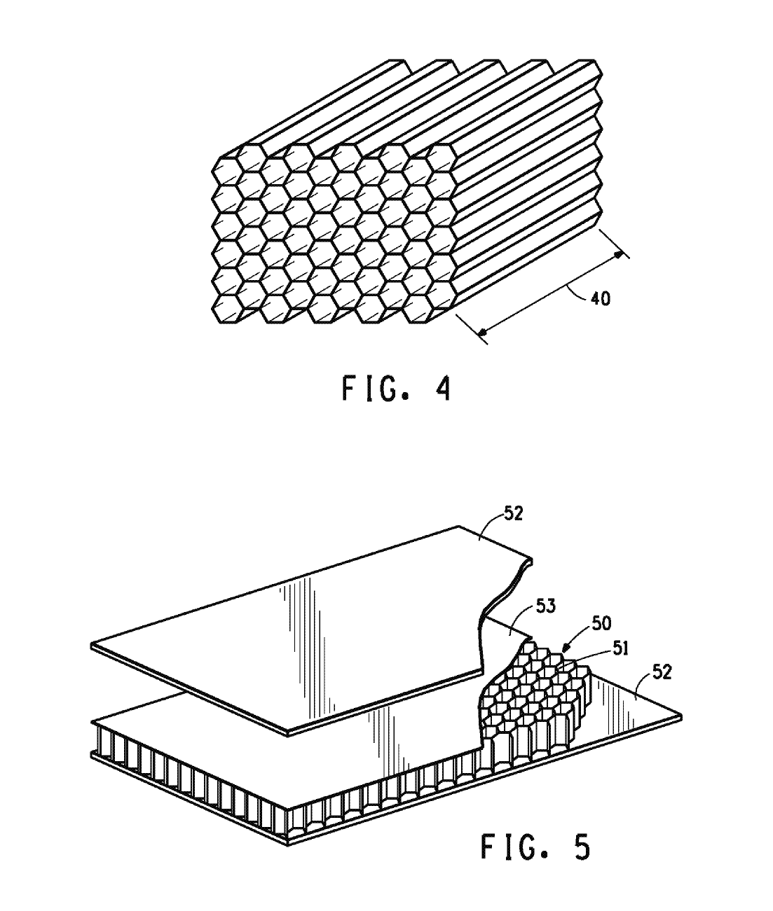

FIG. 5 shows a structural sandwich panel 50 assembled from a thermoplastic honeycomb core 51 with facesheets 52 attached to the two exterior surfaces of the core. The preferred facesheet material is a polymeric film or sheet such as a thermoplastic film. In some embodiments, the facesheets may be a prepreg, a fibrous sheet impregnated with thermoset or thermoplastic resin. In other embodiments, the facesheets may be metallic. In some circumstances an adhesive film 53 is also used. There may be at least two facesheets on either side of the core.

### EXAMPLES

The following examples are given to illustrate the invention and should not be interpreted as limiting it in any way. All parts and percentages are by weight unless otherwise indicated. Examples prepared according to the process or processes of the current invention are indicated by numerical values. Control or Comparative Examples are indicated by letters. Data and test results relating to the Comparative and Inventive Examples are shown in Tables 1 to 4. Extruded flat sheet structures were used to show the advantages of blending fibers with the polymeric material. A similar trend in performance would be noted should the fiber-resin blend be extruded as a honeycomb profile rather than as a flat sheet.

### Examples 1-3

In Examples 1-3, an extruded sheet structure was made from a blend of 57 weight percent polyamide 66 reinforced with 43 weight percent short glass fibers, commercially available from E.I du Pont de Nemours and Company as Zytel® 70G43L. The sheet structure was produced by extruding the fiber-reinforced polyamide onto a belt using a Davis-Standard Model DS15 38 mm (1.5 inches) single-screw extruder. The extruder contained four heat zones. Zones 1 and 2 were set to a temperature of 285 degrees C., and zones 3 and 4 were set to a temperature of 282 degrees C. The initial screw speed was set to 76 rpm, and the exit roll temperature was set to 66 degrees C. Sheets were extruded under these conditions into the three different thicknesses shown in Table 1. The discontinuous fibers were distributed evenly throughout the sheet. The sheet structures were then tested in the machine direction for tensile modulus and strength according to ASTM D882-10. The machine direction the long direction within the plane of the extruded sheet, that is, the direction in which the sheet was made. The results in Table 1 show a significant improvement in the mechanical properties over a Comparative Example of unreinforced polyamide, even with a significant reduction in sheet thickness.

### Comparative Examples A-B

In Comparative Examples A and B, a sheet structure was made from an unreinforced polyamide 66, commercially available from E.I. du Pont de Nemours and Company of Wilmington, Del. as Zytel® E51 HSB. The sheet structure was produced by extruding the polyamide onto a belt using a Davis-Standard Model DS15 38 mm (1.5 inches) single-screw extruder. The extruder contained four heat zones. Zones 1 and 2 were set to a temperature of 285 degrees C., and zones 3 and 4 were set to a temperature of 282 degrees C. The initial screw speed was set to 76 rpm, and the exit roll temperature was set to 66 degrees C. Two sheets of different thicknesses were produced under these conditions and tested in the machine direction according to ASTM D882-10, as shown in Table 1.

TABLE 1

| | Thickness | Modulus | Strength |
|---|---|---|---|
| Example | (mm) | (MPa) | (MPa) |
| 1 | 0.73 | 3,378 | 1,744 |
| 2 | 0.80 | 4,051 | 2,332 |
| 3 | 0.88 | 4,243 | 2,898 |
| Comp A | 0.93 | 727 | 1,570 |
| Comp B | 0.98 | 888 | 1,233 |

### Examples 4-10

In Examples 4-10, polymeric blends were produced from commercially available polymeric materials listed in Table 2. These materials are available from El du Pont de Nemours and Company, Wilmington, Del. The polymeric blends and fiber-polymer formulations made from these raw materials are listed in Table 3. The fiber lengths are in the range of from 3 to 5 mm. Also shown in Table 3 is the weight percent of reinforcing fiber in the final fiber-polymer formulation, the remaining weight percent being the polyamide nylon 6,6.

TABLE 2

| Material Name | Description |
|---|---|
| Zytel ® 70G43L | 43% Glass-reinforced nylon 6,6 |
| Zytel ® E51HSB | Unreinforced, high-viscosity, heat-stabilized |
| | nylon 6,6 |
| Zytel ® FR7026V0F | Flame-retardant, unreinforced nylon 6,6 |
| Zytel ® 70K20HSL | 20% Kevlar ® short fiber-reinforced, heat- |
| | stabilized nylon 6,6 |

TABLE 3

| | Composition of Blend/Compound | | | | Final Component % | | |
|---|---|---|---|---|---|---|---|
| | % | % | % | % | Final % | Final % | Final % |
| Ex Nr. | 70G43L | E51HSB | FR7026V0F | 70K20HSL | Resin | Glass | Kevlar ® |
| 4 | 75 | 25 | — | — | 67.75 | 32.25 | — |
| 5 | 75 | — | 25 | — | 67.75 | 32.35 | — |
| 6 | 70 | 15 | 15 | — | 69.90 | 30.10 | — |
| 7 | — | 25 | 25 | 50 | 90 | — | 10 |
| 8 | — | — | 50 | 50 | 90 | — | 10 |
| 9 | 50 | 25 | — | 25 | 73.5 | 21.5 | 5 |
| 10 | 50 | — | 25 | 25 | 73.5 | 21.5 | 5 |

The fiber-polymer formulations were produced by pre-blending the commercially available component pellets to the desired weight percent ratios. The blended pellets were then fed into a loss-in-weight feed hopper that fed the pellets into a 30 mm single-screw extruder. The material was fed at a speed of 30 pounds per hour under a barrel temperature set-point of 240 degrees C. The screw used was a 25 mm auger-type screw. The final fiber-polymer formulation was then extruded through a 4.76 mm ( 3/16″) hole the and into a water bath for instantaneous cooling. The extruded rope was then fed through a pelletizer. The pellets were collected and dried overnight at 95 degrees C. in a Blue M oven.

After the compounded pellets were dried, the material was then fed into a Nissei 6 oz FN3000 single-screw injection molding machine. The machine was set to a temperature of 290 degrees C. with an injection pressure of 60 MPa to make all-purpose tensile bars.

The all-purpose bars produced from the compounding were then tensile-tested on an Instron® tester according to test method ISO 527-2:2012 for high-tensile fiber-reinforced plastics. The results of the tensile tests can be seen in Table 4 below.

TABLE 4

| | Modulus | Stress at | Tensile Strain |
|---|---|---|---|
| Example | (MPa) | Break (MPa) | at Break (%) |
| 4 | 8736 | 134 | 5.9 |
| 5 | 9093 | 139 | 3.8 |
| 6 | 8240 | 137 | 3.8 |
| 7 | 3867 | 76 | 2.7 |
| 8 | 3849 | 76 | 3.5 |
| 9 | 7024 | 122 | 6.5 |
| 10 | 6605 | 113 | 4 |

Honeycomb structures can be produced in a similar way to Examples 1-10. The same raw materials can be utilized and the required amounts of each calculated from the desired modulus of the honeycomb structure. For example, a fiber-polymer blend can comprise from 40-90% of Zytel® 70G43L and from 10-60% of Zytel® E51 HSB.

### Example 11

A fiber-polymer formulation in pellet form can be prepared by blending 75 weight percent of Zytel® 70G43L and 25 weight percent of Zytel® E51 HSB as per Example 4. The blended pellets can be fed directly to an extruder or to a pelletizing machine for later use as a feedstock for an extruder. The extruder has a die that will produce a honeycomb structure, the dimensions of the die being such that after extrusion and cooling the honeycomb is of the desired dimensions. The extruded structure can also be expanded or stretched at some immediate point after the die while the polymer is still in its softened stage to increase the overall size of the structure. The extruded structure can either be cut to the final dimensions or can have facesheet layers added to the top and bottom, either after the polymer has hardened or while in its softened stage. Such a honeycomb is free of fused cell walls.

### Comparative Example C

Comparative Example C can be prepared as per Example 11 except that only Zytel® E51 HSB ,which contains no reinforcing fibers, is used.

Example 11 will have higher mechanical strength properties such as toughness, shear and compression when compared with Comparative Example C due to the presence of discontinuous reinforcing fibers.

What is claimed is:

1. A honeycomb core comprising from 40 to 90 weight percent of an aliphatic polyamide polymer and from 10 to 60 weight percent of discontinuous fibers distributed evenly throughout the polymer wherein
(i) the honeycomb is free of fused cell walls,
(ii) the fibers are carbon, glass, para-aramid or a combination thereof, and
(iii) the fibers have a length of from 0.5 to 10 mm.

2. The core of claim 1 wherein the fibers are in a random orientation.

3. The core of claim 1 wherein at least 20% of the fibers are oriented in a particular direction.

4. The core of claim 1 wherein the polyamide is nylon 6, nylon 66 or polyphthalamide.

5. A composite panel comprising a honeycomb structure according to any one of the preceding claims and at least one facesheet attached to at least one exterior surface of the honeycomb structure.

6. The panel according to claim 5, wherein the facesheet is a polymeric film, a resin impregnated fiber or a metallic sheet.
